(19) United States
(12) Patent Application Publication
(10) Pub. No.: US 2012/0259062 A1
(43) Pub. Date: Oct. 11, 2012

(54) NOVEL 2C PUR SYSTEMS

(75) Inventors: Thomas Münzmay, Dormagen (DE); Alice Münzmay, Dormagen (DE); Sebastian Dörr, Dusseldorf (DE); Marc Claudius Schrinner, Koln (DE); Martin Melchiors, Leichlingen (DE); Jürgen Lippemeier, Koln (DE)

(73) Assignee: Bayer MaterialScience AG, Leverkusen (DE)

(21) Appl. No.: 13/500,180

(22) PCT Filed: Sep. 30, 2010
(86) PCT No.: PCT/EP10/64527

§ 371 Date: Jun. 27, 2012

(30) Foreign Application Priority Data
Oct. 5, 2009 (EP) 0901245.1

(51) Int. Cl. C09D 175/04; C09J 175/04

(52) U.S. Cl. 524/591

(57) ABSTRACT

The present invention relates to alkali metal salts of phosphomolybdic acid, especially sodium phosphomolybdate, for the accelerated curing of polyisocyanates with polyols, and to polyurethane Systems in which they are present.

The present invention relates to alkali metal salts of phosphomolybdic acid for the accelerated curing of polyisocyanates with polyols, and to polyurethane systems in which they are present.

The present invention relates especially to catalysts for the accelerated curing of polyisocyanates with polyols in the presence of water as solvent (so-called aqueous two-component polyurethane lacquers, or aqueous 2C PUR lacquers).

The use of water as solvent for lacquer applications has increased considerably in recent years. Environmental aspects are playing a decisive role in the development of this technology. The use of organic solvents for applying the lacquer to the substrate can thus be greatly reduced with this technology. This is coupled with a substantial reduction in the emission of volatile constituents (so-called VOCs, or volatile organic compounds) that favour ozone degradation, and an improvement in the users' working conditions. Furthermore, combustion of the exhaust air from paint shops can be largely dispensed with, resulting in cost savings.

For conventional lacquer systems, i.e. those in which organic solvents are used to apply lacquers to the substrate to be lacquered, a number of catalysts have been described which accelerate the reaction of (poly)alcohols with (poly)isocyanates to give polyurethanes. Depending on the desired processing time, a catalyst of appropriate reactivity can be chosen to obtain the desired lacquer properties more rapidly. Typically used catalysts include those based on tin compounds, especially tin(IV) compounds, particular preference being afforded to dibutyltin dilaurate, or DBTL. This compound is probably the most frequently used catalyst for so-called two-component polyurethane (2C PUR) lacquer applications. Tin salts or organotin compounds cause isocyanates to react rapidly with alcohols or polyols. Alternatively it is also possible to use bismuth and zinc compounds. These usually have a longer pot life and reaction time than the tin compounds. The use of zirconium chelate compounds such as zirconium(IV) acetylacetonate has also been described. These have been described inter alia in Journal of Coatings Technology 2002, 74(930), 31-36. A relevant overview of common catalysts is given e.g. by Florio in Paint & Coatings Industry 2000, 16, 80. However, other typical polyurethane catalysts, e.g. iron(III) acetylacetonate or corresponding nickel or cobalt compounds, cannot be used in light-resistant lacquers because these catalysts generally form coloured complexes.

In contrast to conventional solvent-based systems, other facts also have to be taken into account when using water as solvent for lacquer applications. An overview of this problem is given e.g. by W. Blank in Progress in Organic Coatings 1999, 35, 19 and in WO 98/41322 and the literature cited therein.

In these lacquers systems it is necessary to consider the reaction rate of the isocyanate with alcohols relative to the reaction rate with water. The reaction of isocyanates with water leads to the formation of carbamic acid derivatives, which subsequently react to give the corresponding amine and carbon dioxide. The carbon dioxide formed can become noticeable as bubbling in the film, which degrades the quality of the film. The formation of carbon dioxide is undesirable for this reason. The amine liberated from the decarboxylated carbamic acids can react with free isocyanate to give ureas. The excessive formation of ureas in turn becomes noticeable as a shortening of the system's pot life and typically as a loss of surface gloss and a degradation of the properties of the lacquer after the lacquering process.

Thus the reaction of isocyanates with water is undesirable because of the secondary reactions and the rapid loss of properties. Therefore, to prevent a degradation of properties compared with the uncatalysed lacquer system, the reaction of water with isocyanates should not be preferred. A preference for the reaction of (poly)alcohol with the isocyanate component is desirable. Furthermore, catalysts of the state of the art normally have only a finite life in aqueous systems, i.e. the catalyst is hydrolysed more or less rapidly by the action of water. This applies particularly to the tin(IV) compounds readily used in conventional systems, such as the DBTL mentioned earlier, or to bismuth carboxylates such as bismuth(III) 2-ethylhexanoate (K-Kat, King Industries, Norwalk, Conn., USA), as also described in WO 00/47642.

In addition, most of the polyol components used in industry for aqueous 2C PUR applications possess carboxyl groups (neutralized with tertiary amines) which are used for the hydrophilicization of the binder, i.e. for the incorporability of the polyol component in water. Under certain circumstances, due to complexation, these carboxyl groups can lead to an inhibition of the catalytic activity of organotin compounds used as catalysts for aqueous 2C systems. This applies to all highly charged Lewis acids, e.g. compounds of titanium(IV), zirconium(IV), etc. A catalyst which is supposed to be universally usable with a large number of hydrophilicized polyisocyanates and hydrophilicized binders must not exhibit these interactions with the hydrophilicizing agents.

Tin and zirconium compounds have recently been described as catalysts for aqueous 2C systems. According to WO 98/41322, zirconium(IV) acetylacetonate is supposed to contribute to an accelerated curing of the 2-component polyurethane lacquer film in aqueous systems without the resulting lacquer films being qualitatively inferior to those in the uncatalysed case in respect of gloss and bloom. However, WO 98/41322 only gives examples of lacquer systems based on conventional organic solvents. It does not mention examples of lacquers obtained by reacting hydrophilicized binders (polyols) with hydrophilicized polyisocyanates (as such, where an interaction of the hydrophilicizing agent with the catalyst is to be expected). The teaching of WO 98/41322 also describes the addition of a complexing agent (acetylacetone) which first has to evaporate, after application of the lacquer film, in order to initiate the catalysis. This procedure is necessary to minimize the activity of the catalyst during the pot life. If this complexing agent were not used, the pot life would decrease to an unacceptable and impractical level. The complexing agent has the disadvantage of being an additional volatile organic component that causes environmental pollution once again and worsens the user's working conditions.

The object was therefore to find a catalyst for accelerating the reaction of isocyanates with alcohols or polyols in the presence of water, or in general for accelerating the curing of aqueous 2C PUR-based systems. The general lacquer properties as a function of processing time should not suffer due to the use of the catalyst, and the pot life should not be shortened. Ideally the pot life is not affected by the presence of the catalyst. The catalyst should be stable to hydrolysis and exhibit sufficient activity even for very small amounts of active substance. Furthermore, ecological and economic viewpoints (price) should be taken into account.

Surprisingly it has now been found that this object can be achieved with alkali metal salts of phosphomolybdic acid, e.g. sodium phosphomolybdate (Na₃PO₄.12MoO₃.xH₂O).

The compound is an active catalyst for accelerating the reaction of polyisocyanates with polyols in water without shortening the processing time (pot life). No other additives, e.g. complexing agents, are necessary. High-quality polyurethane lacquers are obtained which are qualitatively at least equivalent to the lacquer films formed without catalysis.

The effects of compounds of molybdenum in e.g. oxidation state 6 (for example lithium and sodium molybdate) have already been described in U.S. Pat. No. 2,916,464, but these compounds were used to prepare polyurethane foams by reacting a polyester-polyol with toluylene diisocyanate (TDI) in the presence of water. It is all the more surprising that high-quality, bubble-free, light-resistant lacquer films, which are not foams, can be produced with alkali metal salts of phosphomolybdic acid, preferably sodium phosphomolybdate.

It has now been established that the curing time, i.e. the time required by a fully applied aqueous 2C PUR lacquer or a coating to reach its final properties (e.g. pendulum hardness, drying), can be substantially shortened by the addition of alkali metal salts of phosphomolybdic acid, preferably sodium phosphomolybdate, as catalyst, compared with the uncatalysed case. The coated goods can thus be used much sooner.

The acceleration of the curing reaction is also observed in pigmented systems such as white or red lacquers (cf. Examples 2 and 3). The amount of catalyst must be increased if necessary.

The present invention thus provides two-component polyurethane-based coating systems, characterized in that they essentially contain
(a) optionally hydrophilicized polyisocyanates, optionally in the presence of organic solvents or solvent mixtures,
(b) optionally hydrophilicized compounds with isocyanate-reactive groups, in water and optionally in the presence of organic solvents or solvent mixtures,
(c) alkali metal phosphomolybdates, preferably sodium phosphomolybdate, and
(d) optionally other additives and auxiliary substances,
   the amount of (a)+(b) being from 20 to 99.9999 parts by weight, the amount of (c) being from 0.0001 to 5 parts by weight and the amount of (d) being from 0 to 75 parts by weight, with the proviso that the sum of the parts by weight of the individual components (a) to (d) is 100.

The two-component polyurethane-based systems are preferably aqueous two-component lacquer systems or adhesive systems, very particularly preferably lacquer systems.

The invention also provides a process for the preparation of the two-component polyurethane systems of general composition (a) to (d) which is characterized in that the order in which the components of the lacquer system and the auxiliary substances (a) to (d) are added can be varied at will.

The invention also provides the use of the two-component polyurethane systems according to the invention for the preparation of lacquers, paints and other systems such as adhesives or elastomers.

The invention also provides substrates coated with the 2C PUR systems according to the invention.

In terms of the present invention, two-component systems are understood as meaning coating agents for which the components (a) and (b) have to be stored in separate containers because of their reactivity. The two components are only mixed shortly before application and then generally react without additional activation.

The (poly)isocyanate component (a) consists of any desired organic polyisocyanates with aliphatically, cycloaliphatically, araliphatically and/or aromatically bonded, free isocyanate groups which are liquid at room temperature or are diluted with solvents for this purpose. The polyisocyanate component (a) has a viscosity at 23° C. of 10 to 15,000 mPas, preferably of 10 to 5000 mPas. Particularly preferably, the poly-isocyanate component (a) consists of polyisocyanates or polyisocyanate mixtures with exclusively aliphatically and/or cycloaliphatically bonded isocyanate groups which have a (mean) NCO functionality of between 2.0 and 5.0 and a viscosity at 23° C. of 10 to 2000 mPas.

Preferably, polyisocyanates with free NCO groups are used as crosslinking agents in order to obtain a particularly high technical standard of lacquer from the aqueous two-component polyurethane lacquers. Examples of suitable crosslinking resins are polyisocyanates based on isophorone diisocyanate (IPDI), hexamethylene diisocyanate (HDI), 1,4-diisocyanatocyclohexane, bis(4-isocyanatocyclohexyl)-methane (Desmodur® W, Bayer AG, Leverkusen), 1,3-diisocyanatobenzene, 2,4-and/or 2,6-diisocyanatotoluene (TDI), diisocyanatodiphenylmethane (MDI) and ω,ω′-diisocyanato-1,3-dimethylcyclohexane (H₆XDI). Preferred polyisocyanates are those based on isophorone diisocyanate, hexamethylene diisocyanate, bis(4-isocyanato-cyclohexyl)methane and ω,ω′-diisocyanato-1,3-dimethylcyclohexane (H₆XDI).

Said diisocyanates can optionally be used as such, but normally derivatives of the diisocyanates are used. Suitable derivatives are polyisocyanates containing biuret, isocyanurate, uretdione, urethane, iminooxadiazinedione, oxadiazinetrione, carbo-diimide, acylurea and allophanate groups.

Preferred derivatives are those with isocyanurate, iminooxadiazinedione and uretdione structures. Particular preference is afforded to low-monomer lacquer polyisocyanates with these structural elements from isophorone diisocyanate (IPDI), hexamethylene diisocyanate (HDI), 1,4-diisocyanatocyclohexane and bis(4-isocyanatocyclohexyl)-methane (Desmodur® W).

Triisocyanates such as TIN (triisocyanatononane) are also suitable.

The (poly)isocyanate component (a) can optionally be hydrophilically modified.

Water-soluble or water-dispersible polyisocyanates are obtainable e.g. by modification with carboxylate, sulfonate and/or polyethylene oxide groups and/or polyethylene oxide/polypropylene oxide groups.

The polyisocyanates can be hydrophilicized e.g. by reaction with substoichiometric amounts of hydrophilic monohydric polyetheralcohols. The preparation of such hydrophilicized polyisocyanates is described e.g. in EP-A 0 540 985, p. 3, 1. 55-p. 4, 1. 5. Also suitable are the polyisocyanates containing allophanate groups described in EP-A 0 959 087, p. 3, 1. 39-51, which are prepared by reacting low-monomer polyisocyanates with polyethylene oxide polyetheralcohols under allophanatization conditions. The water-dispersible triisocyanatononane-based polyisocyanate mixtures described in DE-A 10 007 821, p. 2, 1. 66-p. 3, 1. 5, are also suitable, as are polyisocyanates hydrophilicized with ionic groups (sulfonate, phosphonate groups), such as those described e.g. in DE-A 10 024 624, p. 3, 1. 13-33, or in WO 01/88006. External hydrophilicization by the addition of emulsifiers is a further possibility.

The NCO content of the polyisocyanate component (a) used can range from 5 to 25 wt. %, e.g. in the case of so-called polyether allophanates (hydrophilicization with a polyether). The NCO contents for hydrophilicization with sulfonic acid groups can range from 4 to 26 wt. %, these figures being given only by way of example.

Some of the isocyanate components used, e.g. up to one third of the isocyanate groups present, can also be blocked with isocyanate-reactive components, in which case the blocked isocyanate component can be reacted in a later step with more polyol in order to bring about further crosslinking

Examples of suitable blocking agents for these polyisocyanates are monohydric alcohols such as oximes like acetoxime, methyl ethyl ketoxime or cyclohexanone oxime, lactams such as ε-caprolactam, phenols, amines such as diisopropylamine or dibutylamine, dimethylpyrazole or triazole, and dimethyl malonate, diethyl malonate or dibutyl malonate.

It is preferable to use low-viscosity, hydrophobic or hydrophilicized polyisocyanates with free isocyanate groups based on aliphatic, cycloaliphatic, araliphatic and/or aromatic isocyanates, particularly preferably aliphatic or cycloaliphatic isocyanates, since this affords a particularly high standard of properties for the lacquer film. The advantages of the binder dispersions according to the invention are revealed most clearly in combination with these crosslinking agents. These polyisocyanates generally have a viscosity at 23° C. of 10 to 3500 mPas. If required, the poly- isocyanates can be used in a mixture with small amounts of inert solvents in order to lower the viscosity to a value within said range. It is also possible to use triiso-cyanatononane as a crosslinking component, either on its own or in mixtures.

In principle, it is of course also possible to use mixtures of different polyisocyanates.

Examples of suitable compounds with isocyanate-reactive groups (b) are polymers with hydroxyl, sulfonate and/or carboxylate groups, preferably carboxylate groups, and optionally sulfonic acid and/or carboxyl groups, preferably carboxyl groups, said polymers consisting of olefinically unsaturated monomers (so-called polyacrylate-polyols), combinations of diols and dicarboxylic acids (so-called polyester-polyols), combinations of diols, dicarboxylic acids and diisocyanates (so-called polyurethane-polyols) and/or hybrid systems of said classes of polyols, e.g. polyacrylate-polyester-polyols, polyacrylate-polyurethane-polyols or polyester-polyurethane-polyols, which preferably have a molecular weight Mₙ (number-average), as determined by gel permeation chromatography, of 500 to 50,000, especially of 1000 to 10,000, a hydroxyl number of 16.5 to 264 mg KOH/g solid resin, preferably of 33 to 165 mg KOH/g solid resin, an acid number (based on the non-neutralized sulfonic acid and/or carboxyl groups) of 0 to 150 mg KOH/g solid resin, preferably of 0 to 100 mg KOH/g solid resin, and a content of sulfonate and/or carboxyl groups of 5 to 417 milliequivalents/100 g solid, preferably of 24 to 278 milliequivalents/100 g solid.

Particularly preferably, these anionic groups are carboxylate groups. An overview of different binders is given e.g. in EP-A 0 959 115, p. 3, 1. 26-54. However, it is also possible to use simple diol components. In principle, any binders with isocyanate-reactive groups, dissolved or dispersed in water, are suitable as the binder component (b). These also include e.g. polyurethanes or polyureas dispersed in water, which are crosslinkable with polyisocyanates by virtue of the active hydrogen atoms present in the urethane or urea groups. However, polyols, i.e. compounds with free OH groups, are preferred.

The binder component (b) is generally used in the preparation of the coating agents in the form of 10 to 60 wt. %, preferably 20 to 50 wt. %, aqueous solutions and/or dispersions, which generally have a viscosity of 10 to 10⁵ mPa.s/23° C., preferably of 100 to 10,000 mPa.s/23° C., and pH values of 5 to 10, preferably of 6 to 9. Auxiliary solvents can optionally be used.

Depending on the molecular weight of the binder component (b) and its content of anionic groups or free acid groups, especially carboxyl groups, the aqueous systems containing the polymers are true dispersions or colloidally disperse or molecularly disperse dispersions, but they are generally so-called “partial dispersions”, i.e. aqueous systems that are partially molecularly disperse and partially colloidally disperse.

The ratio of isocyanate groups from component (a) to isocyanate-reactive groups such as hydroxyl groups (NCO/OH ratio) from component (b) can cover a wide range. Thus a ratio of 0.2:1.0 to 4.0:1.0 is useful for lacquer applications. A preferred range is 0.35:1 to 2.0:1.0, particularly 1.0:1.0 to 1.5:1.0.

The amounts of catalyst to be used in the case of alkali metal salts of phospho-molybdic acid are very low. In general it is possible to work with an amount of active substance of 1 to 10,000 ppm, the preferred range being from 1 to 5000 ppm, particularly from 1 to 1000 ppm, based on all the components (a) to (d). The efficacy of the catalyst is independent of the way in which it is added. Thus it can be introduced directly into the added water. Alternatively it can also be incorporated into the components (a) and/or (b).

The auxiliary substances and additives (d) conventionally used in lacquer technology, e.g. defoamers, thickeners, pigments, dispersants, other catalysts different from (c), skinning inhibitors, antisettling agents or emulsifiers, can be added before, during or after preparation of the aqueous binder dispersion according to the invention and also in the case of preparation of the coating agents by the addition of at least one crosslinking agent.

As solvents, the two-component polyurethane systems according to the invention contain water and optionally organic solvents or mixtures thereof.

Any known solvents can be used as the organic solvents, preference being afforded to those used in the lacquer industry, such as xylene, butyl acetate, ethyl acetate, butyl glycol acetate, butoxyl, methoxypropyl acetate, hydrocarbons like Solvesso® 100 (Exxon Mobile Chemicals) (solvent naphtha can also be used as an alternative) or N-methylpyrrolidone.

The organic solvents are normally only used, if at all, in the minimum amounts required e.g. to predilute the polyisocyanates (a) used or to prepare the binder component (b) dissolved or dispersed in water.

The lacquers, paints and other formulations are prepared from the two-component polyurethane systems according to the invention by methods known per se. Because of the nature of the polyisocyanate component (a) used and the binder component (b), a suitable procedure, in principle, for preparing the lacquer mixture is simply to bring the components together, with the concomitant use of components (c) and (d), and then to stir or thoroughly mix the ingredients. Depending on the starting materials used, it is possible e.g. to use a dissolver for mixing at higher stirrer speeds (e.g. 2000 rpm). In a large number of practical cases, thorough mixing will be adequately effected simply by stirring, e.g. with a rod. Independently of the chosen preparative method, the aqueous 2-component polyurethane systems according to the invention contain the above-described individual components (a) to (d), it being possible for the amount of (a)+(b) to be from 20 to 99.9999 parts by weight, for the amount of (c) to be from 0.0001 to 5 parts by weight and for the amount of (d) to be 0 to 75 parts by weight, with the proviso that the sum of the parts by weight of the individual components (a) to (d) is 100.

The resulting aqueous coating agents are suitable for all areas of application where aqueous painting and coating systems are used which meet high requirements for the standard of properties of the films, e.g. the coating of mineral building material surfaces, the lacquering and sealing of wood and ligneous materials, the coating of metallic surfaces (metal coating), the coating and lacquering of coverings containing asphalt or bitumen, and the lacquering and sealing of diverse plastic surfaces (plastic coating), as well as high-gloss lacquers and high-gloss finishing enamels.

The aqueous coating agents containing the binder dispersions are used to prepare primers, fillers, pigmented finishing enamels and varnishes, and one-coat lacquers which can be used in one-off and mass production, e.g. in the field of industrial lacquering and automotive first-coat and repair lacquering.

Preferred uses of the aqueous coatings according to the invention are the coating or lacquering of metal surfaces or plastics, or of floors, at the conventional processing temperatures, preferably at room temperature to 140° C. Coupled with very good optical properties of the films and at the same time with a high level of solvent and chemical resistance, these coatings dry rapidly and attain the final properties of the films rapidly.

The coating can be produced by a very wide variety of spraying processes, e.g. compressed air, HVLP, airless, airmix or electrostatic spraying processes. However, the lacquers and coating agents containing the catalysts according to the invention can also be applied by other methods, e.g. brushing, rolling or knife coating.

As it has been possible to show, the final properties of the lacquers or coatings studied can be obtained much more rapidly with the aid of sodium phosphomolybdate than in the uncatalysed case. The acceleration of curing applies not only to varnishes, but also to (pigmented) finishing enamels, aqueous fillers, primers and other coatings, e.g. heavily filled floor coatings. A marked acceleration of lacquer curing is still found even in the case of pigmentation of the finishing enamel.

The efficacy of the catalysts described will be demonstrated below by way of Examples.

### EXAMPLES

As part of the studies into the efficacy of the catalysts for aqueous 2-component polyurethane lacquer systems, the development of the hardness (pendulum hardness) of the lacquer films was determined according to Konig/DIN 53157 as a function of curing time. The chemical/solvent resistance and the gloss of the lacquer films were also studied. The Examples clearly show the acceleration of curing by the increase in pendulum hardness of the lacquer films.

Polyisocyanate component (a) used:
(a1) Bayhydur® VP LS 2319, hexamethylene diisocyanate trimer hydrophilicized by a polyether radical, NCO content 18.0±0.5 wt. %, viscosity at 23° C. approx. 4500 mPas, Bayer AG, Leverkusen. The preparation is as described in EP-A 0 959 087.
(a2) Desmodur® XP 2410, non-hydrophilicized polyisocyanate based on a hexa-methylene diisocyanate trimer, NCO content 23 wt. %, viscosity at room temperature approx. 700 mPas, Bayer AG, Leverkusen. The preparation is as described in DE-A 19 611 849 (e.g. Examples 4 and 5) and DE-A 19 824 485 (e.g. Example 3).
(a3) Bayhydur® XP 2451 (hydrophilicized hexamethylene diisocyanate trimerization and dimerization product, Bayer AG, Leverkusen). Viscosity 1400 mPas, NCO content 18.8 wt. %.

Polyol component (b) used:
(b1) Bayhydrol® VP LS 2235-1, OH content of solid resin: 3.3 wt. %, polyacrylate-polyol, Bayer AG, Leverkusen. The polyol is dispersed in water and has carboxyl groups for hydrophilicization.
(b2) PUR-PAC-polyol. Hybrid binder from polyurethane (the PUR-PAC dispersion is obtained from a polyurethane dispersion (hydrophilicized with hydroxycarboxylic acid, after addition of a diisocyanate to form a prepolymer, followed by dispersion in water and chain extension by addition of a diamine) by polymerization of an acrylate in the PUR dispersion). Laboratory product RSC 1392, Bayer AG, Leverkusen. Preparation instructions: 99.2 g of a polyester, prepared from 47 parts of hexahydrophthalic anhydride and 53 parts of 1,6-hexanediol, with an OH number of 53 and an acid number below 3, are heated to 80° C. together with 9.6 g of 1,4-butanediol and 0.2 g of tin(II) octanoate and kept at this temperature until the solution is homogeneous. 31.2 g of Desmodur® W (Bayer AG, Leverkusen, Del.) are then added over 2 minutes, with stirring, and the reaction mixture is heated to 140° C. and stirred for 2 h at 140° C. The prepolymer is dissolved by adding 46.7 g of propylene glycol n-butyl ether, and the solution is stirred for a further 10 minutes. A solution of 105.2 g of hydroxypropyl acrylate, 41.2 g of styrene and 16.8 g of 2-ethylhexyl acrylate is metered in over 2 h. In parallel, a solution of 24.0 g of ditert-butyl peroxide and 24.0 g of propylene glycol n-butyl ether is added dropwise over 3.5 h. When the addition of solution 1 is complete, a mixture of 38.8 g of hydroxypropyl methacrylate, 19.6 g of n-butyl acrylate, 8.6 g of styrene and 5.0 g of acrylic acid is metered in directly over 1 h.

Following the addition of solution 2, the reaction mixture is stirred for a further 2 h at 140° C. and then cooled to 100° C., 6.5 g of dimethylethanolamine are added and the mixture is homogenized for 10 min. Dispersion is effected by adding 529.3 g of water over 5 minutes. This gives a 39.3 wt. % dispersion with an OH content of 4.5 wt. %, based on solid resin, and a mean particle size of 173.3 nm. The hybrid resin has an average molecular weight M_{w} of 21,382 g/mol.
(b3) Hydrophilicized polyester-polyol. This is the laboratory product WPC 19004, Bayer AG, Leverkusen.

Preparation of a water-thinnable polyester-polyol: 334 g of neopentyl glycol, 638 g of 1,4-cyclohexanedimethanol, 733 g of trimellitic anhydride and 432 g of ε-caprolactam are weighed together into a reactor equipped with a stirrer, a heater, automatic temperature control, a nitrogen inlet, a column, a water separator and a receiver, and, with stirring and the passage of nitrogen, the mixture is heated to 230° C. in such a way that the top column temperature does not exceed 103° C. The water of reaction separates out during this process. Condensation is continued until the acid number is 5 mg KOH/g. The mixture is then cooled to 150° C. and 870 g of neopentyl glycol, 827 g of trimethylolpropane and 1874 g of phthalic anhydride are added. Then, with stirring and the passage of nitrogen, the mixture is heated to 220° C. in such a way that the top column temperature does not exceed 103° C. More water of reaction separates out during this process. When distillation has ended, the water separator is replaced with a distillation bridge and the mixture is stirred at 220° C. until the top column temperature drops below 90° C. The column is removed and, with an increased nitrogen stream, condensation is continued until the acid number is 5 mg KOH/g. The mixture is then cooled to 140° C., 418 g of trimellitic anhydride are added and stirring is continued at 170° C. until the acid number is approx. 35 mg KOH/g. Up to this point in the preparation of the polyester, a total of approx. 1770 g of polyester resin has been removed by sampling and other withdrawals. The mixture is then cooled to 130° C. and 210 g of dipropylene glycol dimethyl ether are added, this being followed by a dissolution time of 1 hour at 100° C. The solution formed is then stirred for 1 hour at 50° C. into a mixture, heated to 50° C., of 134 g of N,N-dimethylethanolamine and 3174 g of deionized water. The resulting product was adjusted to a solids content of approx. 47 wt. % with more water to give a blue-tinged, opaque dispersion with a solids content of 46.7 wt. % of polyester-polyol (measured as non-volatile fraction on a sample in a circulating air oven for 60 min at 125° C.), an acid number of 16.3 mg KOH/g (based on supplied form), an OH number of 116 mg KOH/g (based on solid resin) and a viscosity of 2306 mPa·s at 23° C. The dispersion contains approx. 2.4 wt. % of dipropylene glycol dimethyl ether, approx. 1.7 wt. % of N,N-dimethylethanolamine and approx. 49.2 wt. % of water. The product is further thinnable with water and suitable for use in aqueous two-component polyurethane lacquers.
(b4) Bayhydrol® XP 2457 (anionic polyacrylate-polyol, water-dispersible, Bayer AG, Leverkusen): viscosity 20-200 mPas, OH content 0.8 wt. %.

Catalyst component (c) used—sodium phosphomolybdate:

Sodium phosphomolybdate (c) from Aldrich, Taufkirchen, DE, was used in 10% aqueous solution without further modification.

Said percentages or parts of the starting materials used are understood as wt. % or parts by weight.

### Example 1

Influence of sodium phosphomolybdate on the curing behaviour of an aqueous 2C PUR varnish

TABLE 1
Formulation of an aqueous 2C PUR varnish

| | Parts by weight |
|---|---|
| Component 1 | |
| Polyol component (b1): | 400.0 |
| Bayhydrol ® VP LS 2235 | |
| Surfynol ® 104¹ | 9.1 |
| Borchigel ® PW 25² | 1.2 |
| Baysilone ® VP AI 3468³ | 7.6 |
| Total comp. 1 | 417.9 |
| Component 2 | |
| Polyisocyanate component (a1): | 152.9 |
| Bayhydur ® VP LS 2319 | |
| (80 wt. % in | |
| methoxybutyl acetate) | |
| Total comp. 1 + comp. 2 | 570.8 |
| WR comp. 1 + comp. 2 | 100:36.6 |
| H₂O 25 sec DIN 4 on 100.0 g | 45.6 |

WR = weight ratio
¹Air Products N.L., additive for improving flow, substrate wetting, defoaming
²Borchers GmbH, Monheim, PUR thickener
³Borchers GmbH, Monheim, slip additive

Sodium phosphomolybdate was used in 10% aqueous solution without further modification. All the components of the parent lacquer (component 1) were mixed together and degassed. The lacquer components (components 1 and 2) were then mixed by means of a dissolver at 2000 rpm for 2 minutes. The catalyst was added to the finished lacquer mixture before application and then incorporated mechanically as described above. The lacquer film was knife-coated onto a glass plate.

After curing, the pendulum hardness of the lacquer system is determined (damping of a pendulum by the lacquer surface; the higher the value, the better and more cured the lacquer film).

| | | Sample B |
|---|---|---|
| | Sample A | (molybdophosphate- |
| | (uncatalysed), | catalysed), according to |
| Pendulum hardness | comparison | the invention |
| 22.2° C./52.0% immediately | 34″ | 91″ |
| 22.9° C./52% 1 d RT | 97″ | 98″ |

It was found that the initial hardness could be improved considerably by the system according to the invention without shortening the pot life.

### Sample A:

| Component | Parts by weight |
|---|---|
| Polyacrylate precursor¹ | 2100 |
| Cosolvents^{2,3} | 961 |
| Initiator⁴ | 199 |
| Methyl methacrylate | 1647 |
| Hydroxyethyl methacrylate | 2804 |
| n-Butyl methacrylate | 1448 |
| n-Butyl acrylate | 751 |
| Isobornyl methacrylate | 1784 |
| Acrylic acid | 306 |
| Demineralized water | |

¹Desmophen A 160, 60% in SN 100
²Dow, Dowanol PnB (propylene glycol n-butyl ether)
^{2 and 3}in ratio of 4.5:1
³solvent naphtha 100
⁴Peroxan DB

### Sample B:

| | | Sample B) |
|---|---|---|
| | | according to the |
| | Sample A) | invention, with |
| | comparison | molybdate |
| Component | Parts by weight | Parts by weight |
| Sample A | 774 | 774 |
| Amine^{1,2} | 38.6 | 38.6 |
| Demineralized water | 541 | |
| Demineralized water with | | 541 |
| 1000 ppm of sodium | | |
| phosphomolybdate hydrate | | |

¹triethanolamine
²dimethylethanolamine
^{1 and 2}in ratio of 5:1

1-13. (canceled)

14. A two-component polyurethane-based coating system which consists essentially of
(a) optionally hydrophilicized polyisocyanate,
(b) optionally hydrophilicized compounds with isocyanate-reactive groups, in water and optionally in the presence of organic solvents or solvent mixtures,
(c) alkali metal salts of phosphomolybdic acid, and
(d) optionally other additives and auxiliary substances, the amount of (a)+(b) being 20 to 99.9999 parts by weight, the amount of (c) being 0.0001 to 5 parts by weight and the amount of (d) being 0 to 75 parts by weight, and the sum of the parts by weight being 100.

15. The system according to claim 14, wherein the system is a lacquer system.

16. The system according to claim 14, wherein component (c) is sodium phospho- molybdate.

17. The system according to claim 14, wherein the system is an adhesive system.

18. The system according to claim 14, wherein said polyisocyanate (a) is a polyisocyanate with aliphatically bonded isocyanate groups.

19. The system according to claim 14, wherein said polyisocyanate (a) is a blocked polyisocyanate with aromatically bonded isocyanate groups.

20. The system according to claim 14, wherein said polyisocyanate (a) is a polyisocyanate based on hexamethylene diisocyanate, isophorone diisocyanate or 4,4′-diisocyanatodicyclohexylmethane.

21. The system according to claim 14, wherein the polyisocyanate (a) is a hydrophilically modified.

22. A process for the preparation of the system according to claim 14, which comprises incorporating component (c) into component (a) or (b) during the preparation of the latter.

23. A process for the preparation of the system according to claim 14, which comprises incorportating component (c) into the mixture during the preparation of the ready-to-use system.

24. A process for the preparation of the system according to claim 14, which comprises adding component (c) to one or more of the other components before the introduction of additional water or solvent.

25. A process for the preparation of lacquers, paints, sealants or adhesives which comprises utilizing the system according to claim 14.

26. A substrate coated, sealed or glued with the system according to claim 14.
